(19) United States
(12) Patent Application Publication
(10) Pub. No.: US 2021/0028590 A1
(43) Pub. Date: Jan. 28, 2021

(54) OPTICAL AMPLIFIER, OPTICAL COMMUNICATION SYSTEM AND OPTICAL AMPLIFICATION METHOD

(71) Applicant: NEC Corporation, Tokyo (JP)

(72) Inventors: Emmanuel LE TAILLANDIER DE GABORY, Tokyo (JP); Keiichi MATSUMOTO, Tokyo (JP)

(73) Assignee: NEC Corporation, Tokyo (JP)

(21) Appl. No.: 17/043,569

(22) PCT Filed: Apr. 11, 2018
(86) PCT No.: PCT/JP2018/015208

§ 371 Date: Sep. 29, 2020

(51) Int. Cl. H01S 3/067; H01S 3/30; H01S 3/094; H01S 3/23; H01S 3/16; H04B 10/2581; H04J 14/02; H04B 10/291; H04J 14/04

(52) U.S. Cl. CPC H01S 3/06737; H01S 3/06754; H01S 3/302; H01S 3/094007; H01S 3/094069; H01S 3/2316; H01S 3/09415; H01S 3/1608; H04B 10/2581; H04J 14/0256; H04B 10/2916; H04J 14/04; H01S 3/06716

(57) ABSTRACT

An object is to provide an optical amplifier capable of performing Raman amplification while suppressing power consumption and a size. A multicore fiber has a double clad structure. The double clad structure includes a plurality of cores thorough which an optical signal is transmitted and a clad includes the cores. A light source outputs a pump light used for amplifying the optical signal by stimulated Raman scattering in the multicore fiber. The pump light is generated by multiplexing multimode laser lights. A optical coupler couples the pump light into the clad of the multicore fiber.

### TECHNICAL FIELD

The present invention relates to an optical amplifier, an optical communication system, and an optical amplification method.

### BACKGROUND ART

In a field of optical communication, it is desirable to increase capacity of the optical fiber links. This can be achieved by increasing Spectral Efficiency (SE) of signals transmitted on the optical fiber links. A common way to achieve it is to use more efficient modulation formats for transmitted information. This can be used in conjunction with Wavelength Division Multiplexing (WDM).

Further, Space Division Multiplexing (SDM) is used in order to increase capacity of transmission through one fiber while maintaining possibility of the transmission over long distances.

In NPL1, it is disclosed that the SDM implemented with a Multi Core Fiber (MCF) including seven cores is used to transmit 40 wavelengths of 128 Gb/s PM-QPSK (Polarization Multiplexed-Quadrature Phase Shift Keying) signal over 6,160 km. The MCF consists of several cores conducting optical signals within the same fiber and multicore (MC)-erbium doped fiber amplifier (EDFA), which consists in a fiber amplifier with the MCF as a gain medium. The MC-EDFA pumps each core including a single MCF gain medium with separated pumps, by scheme of direct core pumping. Further, another multicore fiber amplifier in which rare earth is doped in the cores has been proposed in PTL1.

According to the system of NPL1, capacity of the system can be multiplied by the number of cores of the MCF, namely 7 cores in NPL1. By using the MCF, it is possible to use the multiplicity of cores to spatially multiplexing optical signals, in addition to the WDM in each core. Thus, the capacity of transmission through the fibers can be increased without sacrificing the transmission distance.

NPL2 discloses various different amplification methods such as individual core pumping (ICP), shared core pumping (SCP) and common cladding pumping (CCP). In NPL2, these techniques are applied to the MC-EDFA.

Further, Raman amplification is also a well-known amplification process with superior noise characteristics. An example of a Raman amplification scheme has been proposed in NPL3. It relies on stimulated Raman scattering (SRS), where a lower wavelength pump light (higher frequency) amplifies a higher wavelength (lower frequency) signal in the non-linear regime with emission of a phonon in the fiber. Typically, pump lights in a range from 1430 nm to 1490 nm are used to amplify signals in one or both of the C and L bands. The Raman amplification is caused in a wide range in a transmission fiber, so that it is distributed amplification. The noise characteristics of the Raman amplification are superior to that of the EDFA. The Raman amplification can be applied to the EDFA for achieving hybrid EDFA/Raman amplification. However, as described in NPL3, the Raman amplification consumes more electrical power than the EDFA. Therefore, utilization of the Raman amplification with low noise characteristics is limited when electrical supply is limited.

Additionally, two more problems relevant to Raman amplification have been known. First, the pump lights of different wavelengths are multiplexed in a wavelength manner (i.e. with the WDM). However, high power pump lights have broad spectrums and the spectrums of multiplexed pump lights may overlap on several sections. The multiplexing in wavelength domain of overlapping spectrum portions leads to the suppression of the overlap of different pump lights, which is not used for amplification. This leads to additional inefficient power consumption.

Second, the Raman amplification depends on power density of the pump light, which is a ratio of pump light power by a signal effective area, depending on the fiber core. Thus, it is impossible to adjust the Raman amplification depending on the transmission distance, as the fiber core diameter cannot be adjusted without severe degradation of a transmitted optical signal. Therefore, a design of the Raman amplification cannot be optimally designed in term of signal to noise and power consumption from the view point of the transmission distance parameter.

Besides, the Raman amplification has been proposed for the SDM with MCF in PTL2 and NPL4. In this case, the pump lights are provided to the cores in the MCF, respectively, and the Raman amplification is performed in each core. Therefore, the Raman amplification for the SDM with MCF can achieve higher capacity and parallelization.

### CITATION LIST

### Patent Literature

PTL 1: United States Patent Publication No. 2008/0018989
PTL 2: United States Patent Publication No. 2007/0268569

### Non-Patent Literature

NPL 1: H. Takahashi et al., “First Demonstration of MC-EDFA-Repeatered SDM Transmission of 40×128-Gbit/s PDM-QPSK Signals per Core over 6,160-km 7-core MCF”, ECOC 2012, paper Th.3.C.3.
NPL 2: E. Le Taillandier de Gabory et al., “Transmission of 256 Gb/s PM-16QAM Signal through 7-Core MCF and MC-EDFA with Common Cladding and Variable Shared Core Pumping for Reduction of Power Consumption”, ECOC 2017, paper M.1.E.2
NPL 3: J-X. Cai et al., “49.3 Tb/s Transmission Over 9100 km Using C+L EDFA and 54 Tb/s Transmission Over 9150 km Using Hybrid-Raman EDFA”, Journal of Lightwave technology, Vol. 33, No. 13, pages 2724-2734.
NPL 4: T. Mizuno et al., “Hybrid Cladding-pumped EDFA/Raman for SDM Transmission Systems Using Core-by-core Gain Control Scheme”, ECOC 2017, paper M.I.E.3

### SUMMARY OF INVENTION

### Technical Problem

However, the Raman amplification described above has some problems. As described in NPL3, the Raman amplification consumes more electrical power than the EDFA. Therefore, utilization of the Raman amplification with low noise characteristics is limited when electrical supply is limited. Further, the Raman amplification for the SDM with MCF in NPL4 can achieve higher capacity and parallelization. However, it is necessary to provide the pump light to each core so that a large number of devices for providing the pump lights are required. This results in a higher cost and a larger device footprint. Therefore, reduction of power consumption, cost and size of Raman optical amplifiers is required.

The present invention has been made in view of the aforementioned circumstances and aims to provide an optical amplifier capable of performing Raman amplification while suppressing power consumption and a size.

### Solution to Problem

An aspect of the present invention is an optical amplifier including: a multicore fiber having a double clad structure, the double clad structure including a plurality of cores thorough which an optical signal is transmitted and a clad including the cores; a first light source configured to output a first pump light used for amplifying the optical signal by stimulated Raman scattering in the multicore fiber, the first pump light being generated by multiplexing a plurality of first multimode laser lights, and a first optical coupler configured to couple the first pump light into the clad of the multicore fiber.

An aspect of the present invention is an optical communication system including: a first optical communication device configured to output an optical signal; at least one optical amplifier configured to amplify the optical signal output from the first optical communication device; and a second optical communication device configured to receive the optical signal amplified by the optical amplifier, in which the optical amplifier includes: a multicore fiber having a double clad structure, the double clad structure including a plurality of cores thorough which an optical signal is transmitted and a clad including the cores; a first light source configured to output a first pump light used for amplifying the optical signal by stimulated Raman scattering in the multicore fiber, the first pump light being generated by multiplexing a plurality of first multimode laser lights, and a first optical coupler configured to couple the first pump light into the clad of the multicore fiber.

An aspect of the present invention is an optical amplification method including: multiplexing a plurality of first multimode laser lights to generate a first pump light: and coupling the first pump light into a clad of a multicore fiber, in which the multicore fiber has a double clad structure, the double clad structure includes a plurality of cores thorough which an optical signal is transmitted and the clad includes the cores, and the first pump light is used for amplifying the optical signal by stimulated Raman scattering in the multicore fiber.

### Advantageous Effects of Invention

According to the present invention, it is possible to provide an optical amplifier capable of performing Raman amplification while suppressing power consumption and a size.

### BRIEF DESCRIPTION OF DRAWINGS

FIG. 1 is a block diagram schematically illustrating an optical communication system according to a first exemplary embodiment;

FIG. 2 illustrates a configuration of a fiber Raman amplifier according to the first exemplary embodiment;

FIG. 3 illustrates a configuration of the fiber Raman amplifier according to the first exemplary embodiment;

FIG. 4 illustrates a configuration of repeatedly disposed FRAs according to the first exemplary embodiment;

FIG. 5 illustrates simulation results of the fiber Raman amplifier according to the first exemplary embodiment and a comparison example;

FIG. 6 illustrates a configuration of a fiber Raman amplifier according to a second exemplary embodiment;

FIG. 7 illustrates spectrums of lights emitted by lasers and a pump light;

FIG. 8 illustrates a comparison of power consumptions of the lasers:

FIG. 9 illustrates a configuration of a fiber Raman amplifier according to a third exemplary embodiment:

FIG. 10 illustrates a configuration of a fiber Raman amplifier according to a fourth exemplary embodiment:

FIG. 11 illustrates simulations of power of multiplexed optical signals;

FIG. 12 illustrates a configuration of a fiber Raman amplifier according to a fifth exemplary embodiment;

FIG. 13 illustrates simulations of power of multiplexed optical signals: and

FIG. 14 illustrates a configuration of a fiber Raman amplifier according to a sixth exemplary embodiment.

### DESCRIPTION OF EMBODIMENTS

Exemplary embodiments of the present invention will be described below with reference to the drawings. In the drawings, the same elements are denoted by the same reference numerals, and thus a repeated description is omitted as needed.

### First Exemplary Embodiment

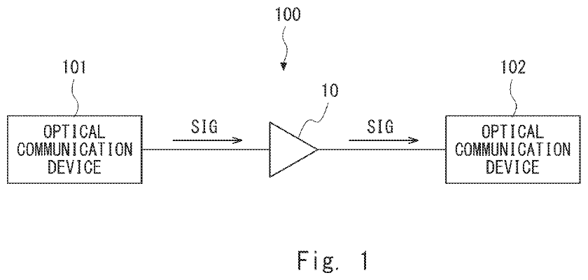

A fiber Raman amplifier according to a first exemplary embodiment will be described. FIG. 1 is a block diagram schematically illustrating an optical communication system 100 according to the first exemplary embodiment. The optical communication system 100 includes optical communication devices 101 and 102, and a fiber Raman amplifier (FRA) 10.

The optical communication devices 101 and 102 include a plurality of transponders and are configured as optical transceivers. In the present exemplary embodiment, an example in which the optical communication device 101 outputs a multiplexed optical signal SIG to the optical communication device 102 through the FRA 10 will be described for simplicity. It should be appreciated that the optical communication device 102 may output the multiplexed optical signal to the optical communication device 101 through the FRA.

The optical communication device 101 outputs the multiplexed optical signal SIG that is generated by multiplexing optical signals emitted by the transponders. Here, the optical signals emitted by the transponders are multiplexed in a wavelength manner (i.e. with WDM [Wavelength Division Multiplexing]) and a special manner (i.e. with SDM [Space Division Multiplexing]).

The multiplexed optical signal SIG output from the optical communication device 101 is attenuated while transmitting to the optical communication device 102. Thus, in the present configuration, at least one FRA 10 is disposed between the optical communication devices 101 and 102 to compensate the attenuation of the multiplexed optical signal SIG.

The FRA 10 is configured as an optical amplifier to amplify the multiplexed optical signal SIG by stimulated Raman scattering (SRS). Note that amplification by the SRS is referred to as Raman amplification. The FRA 10 amplifies the multiplexed optical signal SIG and outputs the amplified signal to the optical communication device 102. Therefore, the optical communication device 102 can receive the multiplexed optical signal SIG that has enough power to be appropriately demodulated.

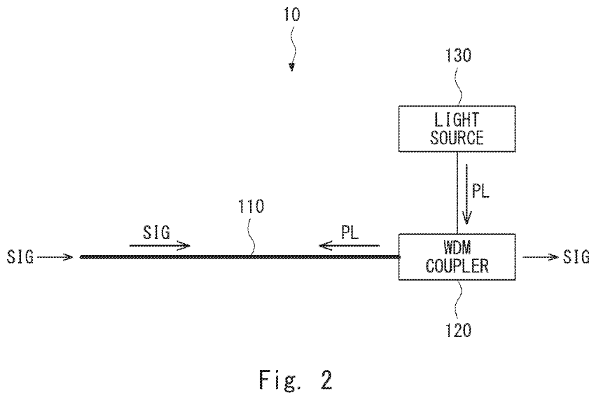

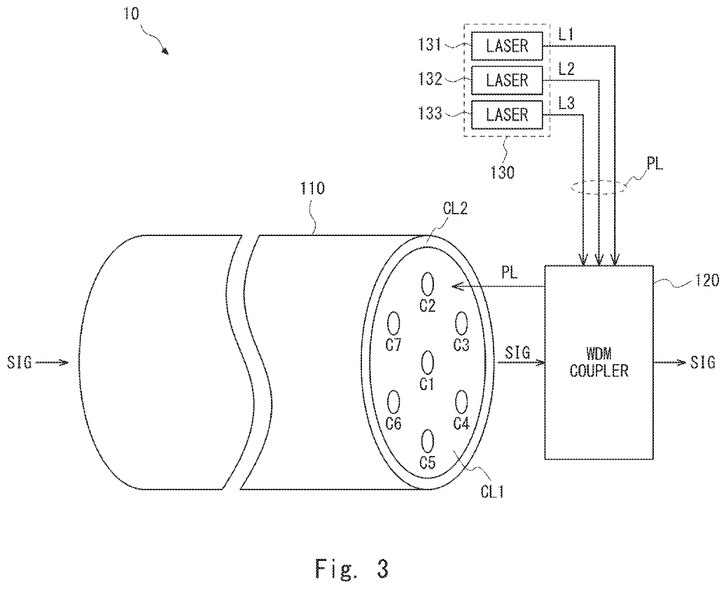

A configuration of the FRA 10 will be described. FIGS. 2 and 3 illustrate the configuration of the FRA 10 according to the first exemplary embodiment. The FRA 10 includes a multicore fiber (MCF) 110, a WDM coupler 120, and a light source 130.

The MCF 110 has a double clad structure and includes seven cores C1 to C7. A length of the MCF 110 is generally several tens of kilometers, for example, 80 km. The multiplexed optical signal SIG output from the optical communication device 101 is transmitted through the cores C1 to C7. In sum, since the optical signals multiplexed with the WDM in the multiplexed optical signal SIG are distributed to the cores C1 to C7, the multiplexed optical signal SIG is multiplexed with the SDM in the MCF 110.

In this structure, the cores C1 to C7 are included in an inner clad CL1 and the inner clad CL1 is included in an outer clad CL2. A refractive index of the outer clad CL2 is lower than that of the inner clad CL1. For example, the outer clad CL2 may be formed by coating on a surface of the inner clad CL1 with a layer of low refractive index resin.

Alternatively, the double clad structure may be configured by a single clad and air (an air layer or an air hole) that surrounds the single clad. In this case, since the refractive index of the air is generally lower than that of the single clad, the single clad can function as the inner clad CL1 and the air can function as the outer clad CL2.

The light source 130 (also referred to as a first light source) includes a plurality of lasers such as laser equipment and laser diodes. In the present exemplary embodiment, the light source 130 includes three lasers 131 to 133 that are multimode lasers. The lasers 131 to 133 respectively outputs laser lights L1 to L3 (also referred to as first multimode laser lights) that are multimode laser lights and provided to the MCF 110 as pump lights. Note that the number of the lasers may be changed as appropriate.

For example, center wavelengths of the laser lights L1 to L3 emitted by the lasers 131 to 133 are distinct in a certain range. The range is typically between 1430 nm and 1490 nm. Power of each of the laser lights L1 to L3 is typically several watts. Each of the lasers 131 to 133 has higher electrical efficiency compared to single mode lasers such as the lasers used in NPL3 and NPL4. All or a part of spectrums of the laser lights may be overlapped.

An output of the MCF 110 (also referred to as a first end) and an output of the light source 130 are connected to the WDM coupler 120. The WDM coupler 120 can output the multiplexed optical signal SIG transmitted though the MCF 110 to the optical communication device 102. The WDM coupler 120 combines the laser lights L1 to L3 emitted by the lasers 131 to 133. In this case, the laser lights L1 to L3 can be multiplexed in wavelength. Further, the laser lights L1 to L3 may be multiplexed in polarization before being multiplexed in wavelength.

The WDM coupler 120 (also referred to as a first optical coupler) couples the combined laser light into the inner clad CL1 of the MCF 110 so as to be transmitted through the inner clad CL1 to an input of the MCF 110 (also referred to as a second end). Thus, the combined laser light, which is a pump light PL (also referred to as a first pump light), is used for pumping simultaneously all the cores C1 to C7. Since the MCF 110 has the double clad structure, as in the case of a MCF without the double clad structure, the pump light PL can be transmitted through the inner clad CL1 without being wasted outside of the inner clad CL1.

Here, a direction in which the multiplexed optical signal SIG is transmitted is defined as a forward direction (also referred to as a first direction). A direction opposite to the forward direction is defined as a backward direction (also referred to as a second direction). In the MCF 110, the pump light PL is transmitted in the backward direction.

In the present exemplary embodiment, the optical communication devices 101 and 102 can emit and receive 200 Gb/s optical signals with a modulation scheme of PM-16QAM (Phase Modulation-16 Quadrature Amplitude Modulation) in 37.5 GHz channel widths. The multiplexed optical signal output from each optical communication device includes optical signals of 100 wavelengths. Each of the cores C1 to C7 can transmit the optical signals of up to 20 Tb/s so that total capacity of the MCF 110 is 140 Tb/s at a maximum.

Next, in order to consider an advantage of the FRA 10, a comparison example in which the pump light is transmitted through the cores will be described. In this example such as the case of NPL4, the Raman amplification is performed directly in the cores of the MCF. In this case, three laser lights are multiplexed in wavelength per core in order to achieve high gain in wide bandwidth. Thus, the comparison example requires three lasers per core.

Therefore, when achieving full capacity of 140 Tb/s in MCF 110, 3*7=21 lasers are required.

In contrast, according to the FRA 10, the Raman amplification of the multiplexed optical signal SIG can be achieved with a small number of the lasers for pumping. Therefore, the present configuration is advantageous for suppressing an entire size of the FRA and being manufactured at low cost.

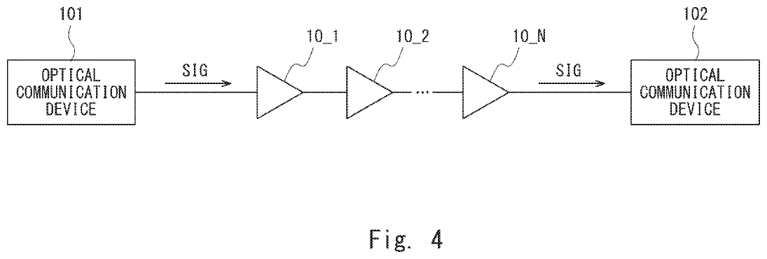

Further, when a distance between the optical communication devices 101 and 102 is as long as several hundred km or more, a plurality of the FRAs may be disposed in series between the optical communication devices 101 and 102. FIG. 4 illustrates a configuration of repeatedly disposed FRAs according to the first exemplary embodiment. As illustrated in FIG. 4. N FRAs 10_to 10_N are disposed in series, where N is an integer more than two.

As described above, one FRA 10 can cover one MCF 110 of 80 km. Thus, the FRAs 10_1 to 10_N can cover N*80 km. For example, when the distance between the optical communication devices 101 and 102 is 400 km, N is set to five. According to this configuration, the multiplexed optical signal SIG is repeatedly amplified by FRAs 10_1 to 10_N so that the attenuation of the multiplexed optical signal SIG due to long-distance transmission can be appropriately compensated.

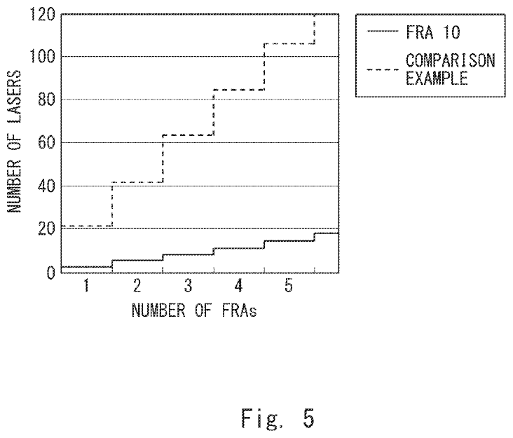

FIG. 5 illustrates simulation results of the present configuration and the comparison example. In FIG. 5, a solid line represents the number of the lasers included in the FRAs according to the first exemplary embodiment. A dashed line represents the number of the lasers when the FRAs according to the comparison example are disposed in series.

In the comparison example, as the number of the FRAs increases by one, the number of the lasers increases by 21. When N=5, the number of the lasers is up to 105. In contrast, according to the present configuration, as the number of the FRAs increases by one, the number of the lasers increases only by 3. When N=5, the number of the lasers is only 15.

Therefore, even when the FRAs are disposed in series, the present configuration enables to reduce the number of lasers for pumping and thereby to suppress the total size and cost of the FRA.

### Second Exemplary Embodiment

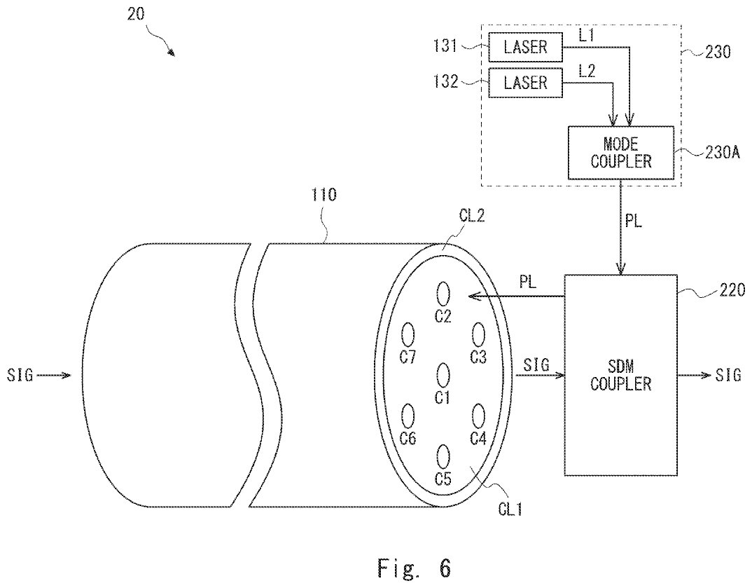

Next, a fiber Raman amplifier according to a second exemplary embodiment will be described. FIG. 6 illustrates a configuration of a FRA 20 according to a second exemplary embodiment. The FRA 20 has a configuration in which the WDM coupler 120 and the light source 130 of the FRA 10 are replaced with a space division multiplex (SDM) coupler 220 (also referred to as the first optical coupler) and a light source 230 (also referred to as the first light source).

The light source 230 includes the lasers 131 and 132, and a mode coupler 230A. In other words, as compared with the light source 130, the light source 230 has a configuration in which the laser 133 is removed and the mode coupler 230A is added. The laser lights L1 and L2 emitted by the lasers 131 and 132 are multiplexed in a modal manner by the mode coupler 230A that performs space division multiplexing on inputs. The multiplexed light, which is the pump light PL, is provided to an input of the SDM coupler 220. The SDM coupler 220 couples the pump light PL to the inner clad CL1 of the MCF 110.

Therefore, according to the present configuration, the multiplexed optical signal SIG transmitted through the MCF is appropriately amplified by the SRS as in the first exemplary embodiment.

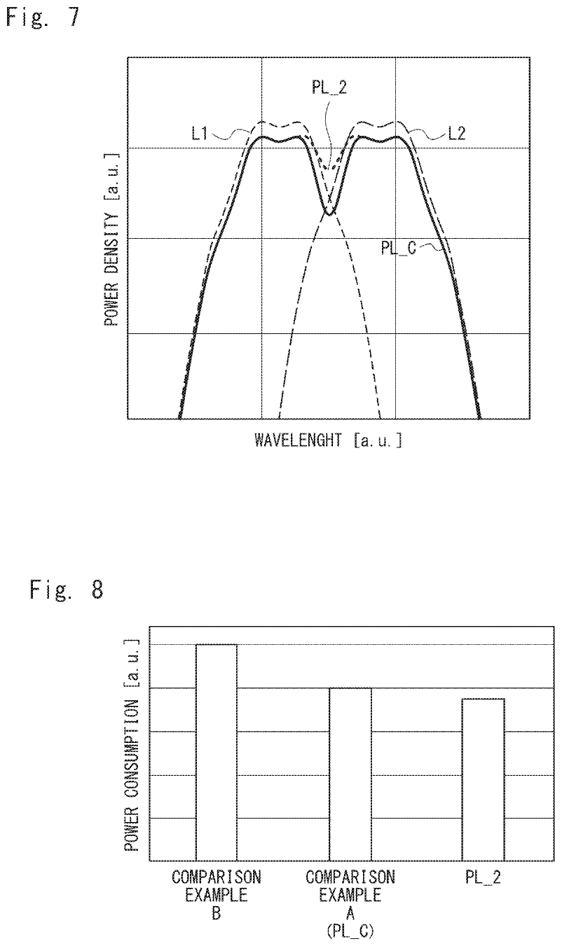

Further, an advantage of the FRA 20 will be described. FIG. 7 illustrates spectrums of the lights L1 and L2, and the pump light PL. In FIG. 7, the pump light PL in the FRA 20 is indicated by PL_2. Further, in FIG. 7, a pump light PL_C in which the laser lights L1 and L2 are multiplexed in the wavelength manner, for example, by the WDM coupler 120 is illustrated as a comparison example A.

As illustrated in FIG. 7, peaks of the pump light PL_2 and PL_C are lower than those of the laser lights L1 and L2 due to insertion loss of the coupler. Additionally, the peaks of the pump light PL_2 and PL_C approximately coincide with each other. However, in a central range between the two peaks, power of the pump light PL_2 is higher than that of the pump light PL_C. This is because the pump light PL_2 has been multiplexed in the modal manner, no longer in the wavelength manner, and thereby the light L1 and L2 can be multiplexed without additional loss.

As a result, according to the present configuration, it is possible to decrease the power of the laser lights emitted by the lasers compared to the FRA 10. FIG. 8 illustrates a comparison of power consumptions of the lasers. In FIG. 8, power consumption of two lasers in NPL4 is also illustrated as a comparison example B. As illustrated in FIG. 8, the FRA 20 can achieve further reduction of power consumption.

### Third Exemplary Embodiment

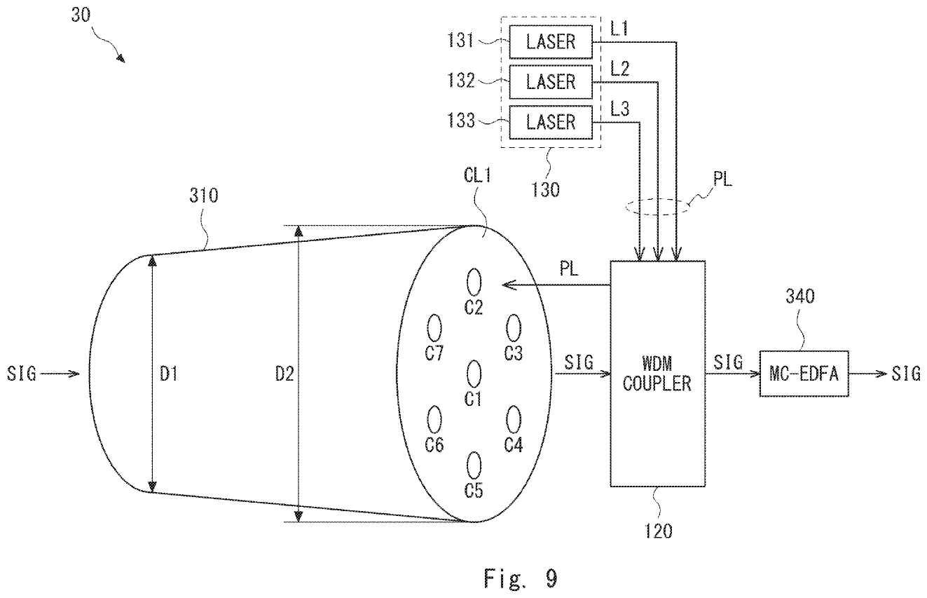

Next, a fiber Raman amplifier according to a third exemplary embodiment will be described. FIG. 9 illustrates a configuration of a FRA 30 according to the third exemplary embodiment. The FRA 30 has a configuration in which the MCF 110 of the FRA 10 is replaced with a MCF 310 and a MC-EDFA (Multi Core-Erbium Doped Fiber Amplifier) 340 is added. In this configuration, the MC-EDFA 340 further amplifies the multiplexed optical signal SIG that is amplified through the MCF 310 by the SRS. Note that the outer clad CL2 is omitted in FIG. 9 for simplicity.

Similarly to the MCF 110, the MCF 310 also includes the cores C1 to C7. However, a diameter D1 of the inner clad CL1 of the MCF 310 at an input end is smaller than a diameter D2 at an output end. The diameter of the inner clad CL1 is continuously changed in the forward direction (or the backward direction). Specifically, the diameter of the inner clad CL1 continuously increases from the input end to the output end.

In this case, the pump light PL is also transmitted in the backward direction as in the first exemplary embodiment. Power density of the pump light PL at the output end of the MCF 310 is reduced due to the large diameter D2 and thereby gain of the Raman amplification is also reduced. Additionally, as a distance from the output end of the MCF 310 increases, the power of the pump light is decreased due to consumption by the SRS.

In sum, in the backward direction, as the power of the pump light PL decreases, the diameter of the inner clad CL1 also decreases. Therefore, the power density of the pump light PL (i.e. the gain of the Raman amplification) is averaged in a wider distance in the backward direction. Further, by appropriately designing the diameter change of the inner clad CL1, the power density of the pump light PL (i.e. the amplitude gain by the SRS) can be kept constant in a wider distance.

Since the power density of the pump light PL is averaged or constant, properties of transmission of the multiplexed optical signal SIG can be unchanged and be kept stable. Therefore, according to the present configuration, it is possible to amplify the multiplexed optical signal SIG by the SRS with higher quality.

### Fourth Exemplary Embodiment

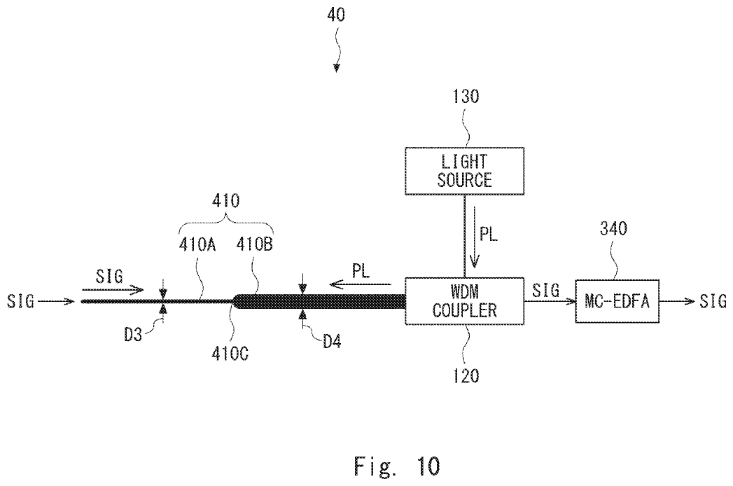

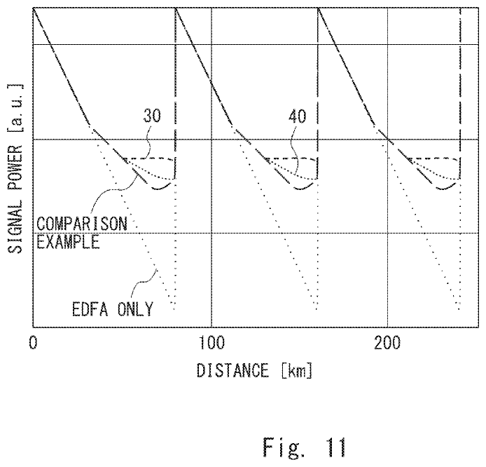

Next, a fiber Raman amplifier according to a fourth exemplary embodiment will be described. FIG. 10 illustrates a configuration of a FRA 40 according to the fourth exemplary embodiment. The FRA 40 has a configuration in which the MCF 310 of the fiber Raman amplifier 30 is replaced with a MCF 410.

The MCF 410 includes MCFs 410A and 410B. The MCF 410A is disposed on an input side of the MCF 410. The MCF 410B is disposed on an output side of the MCF 410. The MCFs 410A and 410B are spliced at a splice point 410C.

Similarly to the MCF 310, the MCFs 410A and 410B also include the cores C1 to C7. A diameter of the inner clad of each of the MCFs 410A and 410B is constant. However, the diameter D3 of the inner clad of the MCF 410A is smaller than the diameter D4 of the inner clad of the MCF 410B.

Similarly to the MCF 310, the power density of the pump light PL can be controlled in the MCF 410 due to the change of the diameter of the inner clad. Thus, as in the third exemplary embodiment, the power density of the pump light PL may be averaged or constant. Therefore, according to the present configuration, it is possible to amplify the optical signals by the SRS with higher quality.

In the present configuration, the diameter of the inner clad is changed in a stepwise manner. As a result, the power density of the pump light PL is controlled more roughly than that in the FRA 30.

FIG. 11 illustrates simulations of power of the multiplexed optical signals. In FIG. 11, the FRA 30, the FRA 40, an EDFA-ONLY case, and a comparison example are illustrated. The EDFA-ONLY case is a case in which the multiplexed by only the MC-EDFA 340 of the FRA 30. The comparison example is a case of NPL4.

Here, three FRAs having MCF of 80 km long are disposed in series so that the power of the multiplexed optical signal SIG is amplified up to the maximum every 80 km by the MC-EDFA. Loss of each MCF of 80 km is 0.2 dB/km.

As illustrated in FIG. 11, the power of the multiplexed optical signal SIG in the EDFA-ONLY case is decreased the most and thereby has the largest dynamic range, because the attenuation is not compensated by the FRA. In the comparison example of NPL4, the multiplexed optical signal SIG is amplified by the SRS so that the power is higher that of the EDFA-ONLY case after 40 km. Generally, as the minimum power becomes higher during transmission, quality of the multiplexed optical signal SIG such as OSNR (Optical Signal to Noise Ratio) at a reception point becomes higher. Therefore, the quality of the multiplexed optical signal SIG in the comparison example is higher than that of the EDFA-ONLY case.

Further, in the FRAs 30 and 40, the Raman amplification in the backward direction is controlled by the diameter of the inner clad of the MCF. Thus, in the FRAs 30 and 40, the power of the multiplexed optical signal SIG is advantageously compensated compared to the comparison example. As a result, the minimum power of the multiplexed optical signal SIG in each of the FRAs 30 and 40 is higher than that of the comparison example. Therefore, according to the FRAs 30 and 40, the quality of the multiplexed optical signal SIG at the reception point can be further higher.

However, as described above, since the power density of the pump light PL in the FRA 40 is controlled more roughly than that in the FRA 30, the power of the multiplexed optical signal SIG in the FRA 40 is decreased at a bottom area more than that of the FRA 30.

However, the configuration of the MCF 310 in the FRA 30 is more complex than that of the MCF 410. Thus, it is relatively difficult to manufacture the MCF 310 having the continuously changed diameter. In contrast, the MCF 410 has a simple configuration in which the MCFs 410A and 410B having different diameters from each other are spliced. Therefore, although an effect of averaging the power density of the pump light PL is inferior to that of the MCF 310, the MCF 410 can be manufactured more easily than the MCF 310.

Therefore, according to the present configuration, it is possible to provide the FRA capable of achieving both of low cost manufacturing and amplification of the multiplexed optical signal with high quality.

### Fifth Exemplary Embodiment

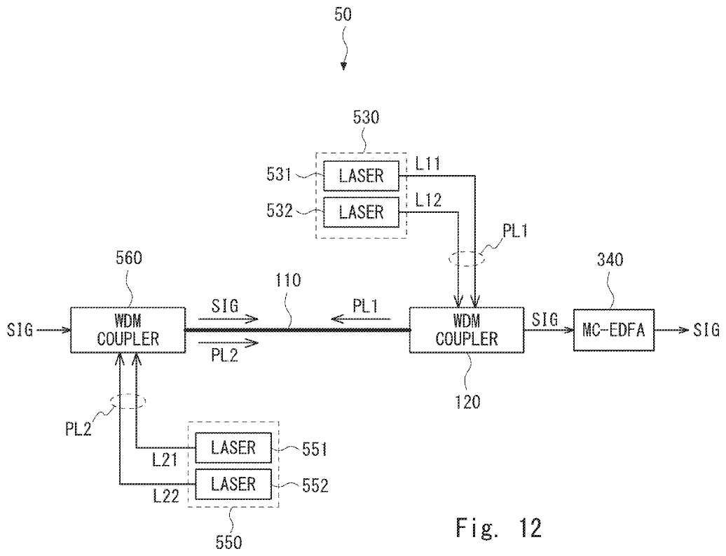

Next, a fiber Raman amplifier according to a fifth exemplary embodiment will be described. FIG. 12 illustrates a configuration of a FRA 50 according to the fifth exemplary embodiment. The FRA 50 has a configuration in which the MCF 310 of the FRA 30 is replaced with the MCF 110, the light source 130 is replaced with light sources 530 and 550, and a WDM coupler 560 is added. The WDM coupler 560 is disposed at the input end of the MCF 110.

The light source 530 (also referred to as the first light source) includes lasers 531 and 532 (also referred to as first lasers) that are the same as the lasers L131 and L132. The lasers 531 and 532 emit the laser lights L11 and L12, respectively. The laser lights L11 and L12 are multiplexed in the WDM coupler 120 and the multiplexed light that is a pump light PL1 (also referred to as the first pump light) is coupled into the inner clad CL1. The pump light PL1 is transmitted in the backward direction.

The light source 550 (also referred to as a second light source) includes lasers 551 and 552 (also referred to as second lasers) that are the same as the lasers L131 and L132. The lasers 551 and 552 emit the laser lights L21 and L22 (also referred to as second multimode laser lights), respectively. The laser lights L21 and L22 are multiplexed in the WDM coupler 560 (also referred to as a second optical coupler) and the multiplexed light that is a pump light PL2 (also referred to as a second pump light) is coupled into the inner clad CL1. The pump light PL2 is transmitted in the forward direction.

As described above, as a distance from the output end of the MCF 110 (or the WDM 120) increases, power density of the pump light PL1 decreases. In contrast, the distance from the output end of the MCF 110 (or the WDM 120) increases, power density of the pump light PL1 increases. In sum, the decrease of the power density of the pump light PL1 can be compensated by the increase of the pump light PL2. As a result, the total power density of the pump lights PL1 and PL2 can be averaged. Further, by appropriately designing the MCF 110 and setting power of the pump lights, the total power density of the pump lights PL1 and PL2 (i.e. the gain of Raman amplification) can be kept constant in a wider distance.

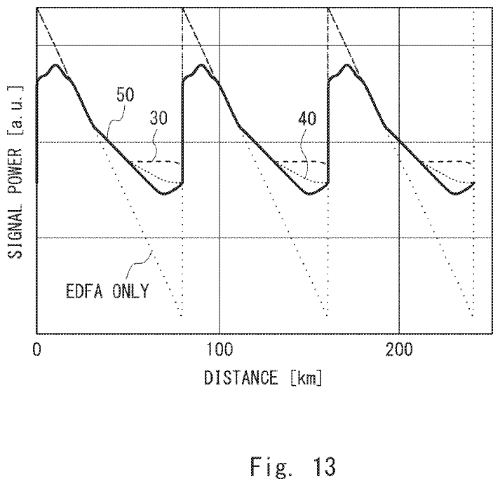

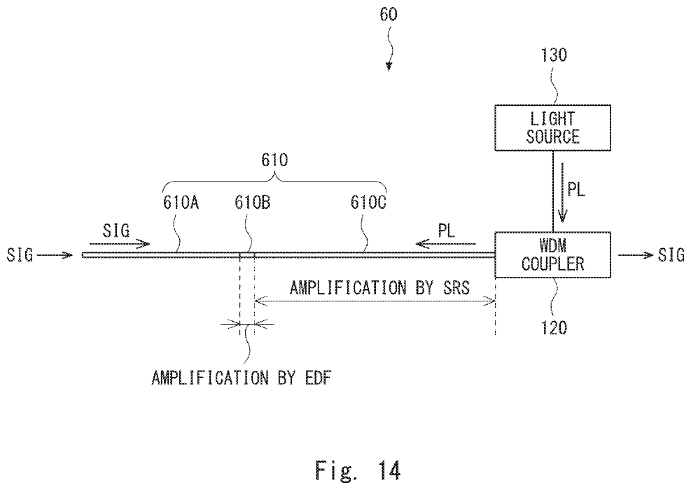

FIG. 13 illustrates simulations of power of the multiplexed optical signals. In FIG. 13, the FRAs 30, 40 and 50, and the EDFA-ONLY case are illustrated. As in FIG. 11, the EDFA-ONLY case is a case in which the multiplexed by only the MC-EDFA 340 of the FRA 30. As in FIG. 13, the three FRAs having MCF of 80 km long are disposed in series so that the power of the multiplexed optical signal SIG is amplified up to the maximum every 80 km.

As illustrated in FIG. 13, a dynamic range of the power of the multiplexed optical signal SIG in the EDFA-ONLY case is decreased the most, because the attenuation is not compensated by the FRA. In the FRA 50, the power of the multiplexed optical signal from the input end (0 km) to the 15 km in which the Raman amplification pumped by the PL2 is strong. Thus the power of the multiplexed optical signal SIG can be reduced, because Raman amplification pumped by the PL2 can compensate the reduction of the power. Note that the reduction of the power can be achieved by controlling an output power of the optical communication device 101 and the amplification by the MC-EDFA 340 in the former FRA as appropriate.

Generally, signal distortion due to nonlinear impairments that result from Kerr effect can be reduced by suppressing the amplification of the optical signal. Therefore, according to the present configuration, it is possible to further improve the quality of the multiplexed optical signal at the reception point.

### Sixth Exemplary Embodiment

Next, a fiber Raman amplifier according to a sixth exemplary embodiment will be described. FIG. 14 illustrates a configuration of a FRA 60 according to the sixth exemplary embodiment. The FRA 60 has a configuration in which the MCF 110 of the FRA 10 is replaced with the MCF 610.

The MCF 610 includes a MCF 610A, a MC-EDFA 610B and a MCF 610C. The MCF 610A, the MC-EDFA 610B and the MCF 610C are connected in series in the forward direction. The MCF 610A and the MCF 610C have the same configuration as the MCF 110. The MC-EDFA 610B includes the cores C1 to C7 as in the MCF 110. A length of the MC-EDFA 610B is typically several tens of meters. A length of the MCF 610C is typically several tens of kilometers.

In the light source 130, a central wavelength of the laser 131 is 1480 nm that is suitable for amplification by the EDFA. Output power of the laser 131 and is set higher than those of the lasers 132 and 133.

Next, an optical amplification in the MCF 610 will be described. The pump light PL transmitted in the backward direction is attenuated due to the Raman amplification in the MCF 610C. However, the output power of the laser 131 is higher than those of the lasers 132 and 133, the laser light L1 is not completely attenuated in the MCF 610C and thereby the remaining laser light L1 is incident on the MC-EDFA 610B. Therefore, the MC-EDFA 610B is pumped by the remaining laser light L1 and the multiplexed optical signal SIG is amplified by the MC-EDFA 610B.

According to the present configuration, the multiplexed optical signal SIG can be amplified not only by the Raman amplification in the MCF 610C but also by the MC-EDFA 610B without disposing additional lasers for pumping the MC-EDFA 610B.

When the additional lasers for pumping the MC-EDFA 610B are required, the additional lasers are disposed at a location separated from the light source 130 by several tens of kilometers. In this case, since it is necessary to supply power to the separated locations, a configuration for power supply has relatively large size. In contrast, according to the present configuration, since the additional lasers for pumping the MC-EDFA 610B are not required, a size of the FRA can be suppressed.

As described above, the present configuration can effectively amplify the optical signal with a compact configuration.

### Other Embodiments

Note that the present invention is not limited to the above exemplary embodiments and can be modified as appropriate without departing from the scope of the invention. For example, the number of cores may be any number more than or equal to two.

In the first, second and sixth exemplary embodiments, the MC-EDFA may be disposed as in the third to fifth exemplary embodiments. The number of the MC-EDFA is not limited to one and a plurality of the MC-EDFAs may be disposed in the FRAs according to the exemplary embodiments described above. In this case, the MC-EDFAs may be disposed in series between the FRA and the optical communication devise. Further, other fiber amplifiers in which rare earth other than Erbium is doped may be used instead of the EDFA.

The light sources 130 and 530 may have a configuration such as the light source 230 in which laser lights are multiplexed in a modal manner. In this case, the WDM couplers 120 may be replaced with the SDM coupler such as the SDM coupler 220.

In the fifth exemplary embodiment, the light source 550 may have a configuration such as the light source 230 in which laser lights are multiplexed in a modal manner. In this case, the WDM coupler 560 may be replaced with the SDM coupler such as the SDM coupler 220. Further, all or a part of spectrums of the laser lights in the light source 560 may be overlapped.

### REFERENCE SIGNS LIST

10, 10_1 TO 10_N, 20, 30, 40, 50, 60 FIBER RAMAN AMPLIFIERS
100 OPTICAL COMMUNICATION SYSTEM
101, 102 OPTICAL COMMUNICATION DEVICES
110, 310, 410, 410A, 410B, 610, 610A, 610C MULTICORE FIBERS
120, 560 WDM COUPLERS
130, 230, 550 LIGHT SOURCES
131 TO 132, 531, 532, 551, 552 LASERS
220 SDM COUPLER
230A MODE COUPLER
340, 610B MC-EDFAS
C1 TO C7 CORES
CL1 INNER CLAD
CL2 OUTER CLAD
L1 TO L3, L11, L12, L21, L22 LASER LIGHTS
PL, PL1, PL2 PUMP LIGHTS

1. An optical amplifier comprising:
a multicore fiber having a double clad structure, the double clad structure including a plurality of cores thorough which an optical signal is transmitted and a clad including the cores;
a first light source configured to output a first pump light used for amplifying the optical signal by stimulated Raman scattering in the multicore fiber, the first pump light being generated by multiplexing a plurality of first multimode laser lights, and
a first optical coupler configured to couple the first pump light into the clad of the multicore fiber.

2. The optical amplifier according to claim 1, wherein all or a part of spectrums of the first multimode laser lights are overlapped.

3. The optical amplifier according to claim 1, wherein the first multimode laser lights are multiplexed in a wavelength manner or in a modal manner to generate the first pump light.

4. The optical amplifier according to claim 1, wherein
the optical signal is transmitted through the multicore fiber in a first direction, and
the first pump light is transmitted through the multicore fiber in a second direction opposite to the first direction.

5. The optical amplifier according to claim 4, wherein the first optical coupler is disposed at a first end of the multicore fiber, the optical signal transmitted and amplified through the multicore fiber is output from the first end of the multicore fiber.

6. The optical amplifier according to claim 4, wherein a diameter of the clad is continuously increased in the first direction.

7. The optical amplifier according to claim 4, wherein
the multicore fiber includes a plurality of sections of multicore fiber,
diameters of the clads of the sections are distinct and increased in the first direction.

8. The optical amplifier according to claim 4, further comprising:
a second light source configured to output a second pump light used for amplifying the optical signal by the stimulated Raman scattering in the multicore fiber, the second pump light being generated by multiplexing a plurality of second multimode laser lights; and
a second optical coupler configured to couple the second pump light into the clad of the multicore fiber, wherein
the second pump light is transmitted through the multicore fiber in the first direction.

9. The optical amplifier according to claim 8, wherein all or a part of spectrums of the second multimode laser lights are overlapped.

10. The optical amplifier according to claim 8, wherein the second multimode laser lights are multiplexed in a wavelength manner or a modal manner to generate the second pump light.

11. The optical amplifier according to claim 8, wherein the second optical coupler is disposed at a second end of the multicore fiber, the optical signal is input to the second end of the multicore fiber.

12. The optical amplifier according to claim 1, wherein
the multicore fiber includes a part of multicore fiber amplifier and a part of multicore fiber,
rare earth is doped in the cores of the part of multicore fiber amplifier, and
the part of multicore fiber is connected between the part of multicore fiber amplifier and the first optical coupler.

13. An optical communication system comprising:
a first optical communication device configured to output an optical signal;
at least one optical amplifier configured to amplify the optical signal output from the first optical communication device; and
a second optical communication device configured to receive the optical signal amplified by the optical amplifier, wherein
the optical amplifier comprises:
a multicore fiber having a double clad structure, the double clad structure including a plurality of cores thorough which an optical signal is transmitted and a clad including the cores;
a first light source configured to output a first pump light used for amplifying the optical signal by stimulated Raman scattering in the multicore fiber, the first pump light being generated by multiplexing a plurality of first multimode laser lights, and
a first optical coupler configured to couple the first pump light into the clad of the multicore fiber.

14. The optical communication system according to claim 13, wherein two or more optical amplifiers are disposed in series between the first and second optical communication devices.

15. An optical amplification method comprising:
multiplexing a plurality of first multimode laser lights to generate a first pump light; and
coupling the first pump light into a clad of a multicore fiber, wherein
the multicore fiber has a double clad structure,
the double clad structure includes a plurality of cores thorough which an optical signal is transmitted and the clad includes the cores, and
the first pump light is used for amplifying the optical signal by stimulated Raman scattering in the multicore fiber.
